(19) United States
(12) Patent Application Publication
(10) Pub. No.: US 2022/0316535 A1
(43) Pub. Date: Oct. 6, 2022

(54) SHIFTING SLEEVE SUPPORT

(71) Applicant: Schaeffler Technologies AG & Co. KG, Herzogenaurach (DE)

(72) Inventors: Martin Dressel, Nürnberg (DE); Alexander Schnotz, Nürnberg (DE)

(73) Assignee: Schaeffler Technologies AG & Co. KG, Herzogenaurach (DE)

(21) Appl. No.: 17/764,684

(22) PCT Filed: Oct. 9, 2020
(86) PCT No.: PCT/DE2020/100876

§ 371 Date: Mar. 29, 2022

(30) Foreign Application Priority Data
Oct. 28, 2019 (DE) 10 2019 129 012.0

(51) Int. Cl. F16D 23/06

(52) U.S. Cl. CPC F16D 23/06; F16D 2023/0631; F16D 2023/0637

(57) ABSTRACT

A shifting sleeve support of a synchronisation device includes an outer toothing for meshing with a shifting sleeve and a groove, which interrupts the outer toothing. The groove has groove walls with an asymmetrical cross-section, and a groove bottom. The groove may form a pressure piece receptacle, a stop for the shifting sleeve, or a stop for a synchroniser ring, for example.

### CROSS-REFERENCE TO RELATED APPLICATIONS

This application is the United States National Phase of PCT Appln. No. PCT/DE2020/100876 filed Oct. 9, 2020, which claims priority to German Application No. DE102019129012.0 filed Oct. 28, 2019, the entire disclosures of which are incorporated by reference herein.

### TECHNICAL FIELD

The present disclosure relates to a shifting sleeve support of a synchronisation device with an outer toothing for meshing with a shifting sleeve and a groove, which interrupts the outer toothing, which groove has groove walls and a groove bottom.

### BACKGROUND

Synchronisation devices are used in different variants in transmissions for motor vehicles. They are used to adjust the speed between the gear Wheels to be coupled with different gear ratios and thus to reduce the shifting force and wear in the transmission and to improve shifting comfort. A frequently used variant of the synchronisation device is designed as a blocking synchronisation system and has a conical friction clutch, which can be designed as a single-cone synchronisation system or as a multi-cone synchronisation system. During synchronising, the different speeds of the gear wheel to be shifted and the main transmission shaft are matched to each other. The gear wheel is then coupled to the shaft by means of an interlocking connection.

A synchronisation device for transmissions of a known type with multiple pressure pieces in the shifting sleeve support is known, for example, from DE 10 2005 054 085 A1. Blocking synchronisations usually have a shifting sleeve support, also called a synchronous carrier body, with multiple pressure pieces distributed over the circumference as locking elements, which are biased in the radial direction by means of springs and are arranged in grooves.

Such grooves are designed as receptacles and guides of pressure pieces and sliding pieces and to accommodate combinations of pressure pieces and latching elements on shifting sleeve supports. A shifting sleeve support with grooves of the type in question is described in DE 195 80 558 A1. The grooves are recesses, the depth of which extends radially in the direction of the axis of rotation of the shifting sleeve support into the shifting sleeve support and which extend in the same direction as the axis of rotation of the shifting sleeve support. They are open at the ends towards the end faces of the shifting sleeve support and can accommodate the pressure pieces which protrude at least at times beyond the end faces of the shifting sleeve support. The invention further relates to all grooves, e.g., for rotationally fixed entrainment of synchroniser rings or the like, which interrupt the ring gear formed or fastened radially on the outside of the shifting sleeve support on the circumferential side of the shifting sleeve support. Further shifting sleeve supports are known from DE 10 2007 031 300 A1, DE 10 2016 122 729 A1 and DE 198 53 896 A1.

The grooves are notches on the shifting sleeve support. The notches have an adverse effect on the distribution of the stresses arising from the reaction forces of the outer toothing in the material of the ring gear. Particular attention must therefore be paid to the design of the grooves. In a circumferentially uninterrupted and thus circumferentially closed circumferential ring gear, the stresses are generally distributed evenly in the ring gear and the shifting sleeve support and are kept at a level that the material can bear. In the case of interrupted ring gears, stress peaks occur in the grooves, particularly on the inner edges. These edges extend in the groove over the entire width of the shifting sleeve support from one end face to the other. The stress peaks are high particularly at the inner edges where the groove of the side walls merges into the groove bottom. These inner edges are at risk of cracking.

Attempts have therefore been made in the past to reduce the notch stresses. For example, the sharp-edged transitions are replaced by a transition with a radius or by a groove that is prepared in the manner of an undercut and runs transverse to the direction of rotation. In another design of the transitions, each of the two lateral walls delimiting the groove is convexly bulged in one of the directions of rotation in the manner of a fillet groove in the material of the shifting sleeve support. The groove is widened at the transition transverse to the axis of rotation. The resulting curved wall surface then merges into the groove bottom.

At high torques, however, these measures are not sufficient. Therefore, in shifting sleeve supports made from cold-formed and/or stamped sheet metal, the material thickness of the starting material is increased. The advantages, such as the low material consumption in the manufacture of the components or the low weight of the shifting sleeve supports, are at least partially eliminated. The energy balance is adversely affected in the production of the shifting sleeve support due to the higher material consumption and in the use of the transmissions due to the higher weight.

### SUMMARY

The object of the present disclosure is therefore to design shifting sleeve supports with grooves in such a way that cracks as a result of stress peaks from high torques in the grooves are avoided. However, the use of more material in the production of the shifting sleeve supports should be avoided as far as possible.

In the vehicle, the shifting sleeve support is sometimes in overrun mode and sometimes in traction mode. Depending on the operating mode, the shifting sleeve support transmits torques in different directions. The edges of the body that are on the load side are subjected to greater loads than the rear edges of the body on the opposite side. In order to take both operating modes into account, the prior art shifting sleeve supports are therefore designed symmetrically. This has the further advantage that they do not have to be installed in a direction-oriented manner.

The present disclosure is based on the fact that, on the one hand, individual maximum loads are not responsible for the formation of cracks, but that material fatigue during continuous loading has a significant influence. On the other hand, the time shares of the overrun mode and the traction mode differ. As a result, the loads on the grooves are not the same over the running time, but rather cracks generally form on the side with the higher load at the end of the service life. According to the disclosure, the grooves are therefore to be designed asymmetrically in order to relieve the more heavily loaded groove region in the direction of torque transmission at the expense of the opposite groove region. The form of asymmetry depends on the predicted shares of the overrun mode and traction mode as well as the basic form predetermined by their function.

The asymmetry of the groove walls is not used to create a stop or to provide a functional surface for another component, but rather to equalize the uneven stress distribution in the shifting sleeve support that is introduced on account of the preferred direction of rotation.

The groove design can be applied to all grooves of the shifting sleeve support. In a first variant, the asymmetrical groove accommodates a pressure piece. For this purpose, a groove bottom which is not subject to asymmetry can be provided in the asymmetrical groove. It can thus guide the pressure piece, for example.

In a second variant, the groove forms a stop for the shifting sleeve that meshes with the outer toothing. The shifting sleeve runs on the shifting sleeve support, and the pressure piece is disposed between the two. If a gear is engaged or disengaged, the shifting sleeve is axially displaced on the shifting sleeve support in one direction or the other. In order to limit this travel geometrically, an end-stop function is required; the shifting sleeve must be stopped mechanically at the end of its travel during the shifting process. To do this, teeth can be cut out on the shifting sleeve. Instead, a stop is integrated into it. When the shifting sleeve is deflected, it runs at the end against a clutch body, so the shifting sleeve is in its end position and cannot be displaced any further. To enable the stop to be displaced axially on the shifting sleeve, the groove in this variant forms a window for the stop.

In a third variant, the groove forms a stop for a synchroniser ring. With this stop, the shifting sleeve support specifies a torsion angle window for the synchroniser ring.

In a simple case, the asymmetry of the groove walls can be described by two surfaces that are inclined differently with respect to the groove bottom.

In another embodiment, the groove walls are curved differently. The curvatures can be constant in each case, but can also change over the curve length. In the latter. the same curvature can be realized in the region in which the two curves merge into the groove bottom and thus no local stress peaks occur. This is helpful in this region of the lowest radial extension of the shifting sleeve support. In a further development, the groove walls are each composed of multiple curves with different curvatures. The groove walls can also have curvatures that change continuously.

In a further embodiment, the groove is asymmetrical in longitudinal section. The asymmetry is therefore not only present in cross section, i.e., transverse to the axis of rotation of the shifting sleeve support, but also in longitudinal section. The torques to be transmitted depend on the transmission ratio. Depending on the average torques transmitted in a gear, the groove bottom can be formed in order to achieve a more uniform load over the running time. In particular, the groove depth can vary. Also, the individual cross-sectional profiles do not have to be similar to one another. This means that the local curvature of the groove bottom in the longitudinal profile can change to different extents. The stresses on the more heavily loaded side are thus reduced and the stresses on the less heavily loaded side are increased. Overall, this increases the operational stability of the shifting sleeve support.

The groove is generally designed as an axial groove and thus runs parallel to the axis of rotation of the shifting sleeve support. It is also generally designed to be open on both end faces of the shifting sleeve support. In particular, if the shifting sleeve support only shifts a gear on one side, for example the reverse gear, the groove can also be closed at the end so that more material is available for torque transmission.

The present disclosure is particularly suitable for sintered shifting sleeve supports. In this way it is possible to specify the three-dimensional shape of the groove without incurring any additional costs in production. Depending on the manufacturing process, this is also possible with a shifting sleeve support made of steel.

### BRIEF DESCRIPTION OF THE DRAWINGS

The present disclosure is illustrated in more detail below by means of drawings based on exemplary embodiments. In the figures,

FIG. 1 shows a synchronisation device in longitudinal section,

FIG. 2 shows a shifting sleeve support according to the prior art in cross section,

FIG. 3 shows a simplified, schematic cross-sectional illustration of the groove of a shifting sleeve support according to the present disclosure.

### DETAILED DESCRIPTION

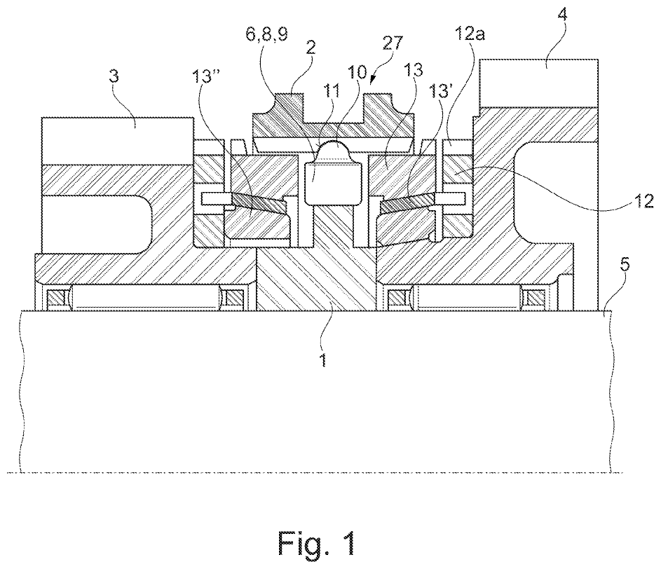

FIG. 1 shows a synchronisation device 27 with a shifting sleeve support 1 and a shifting sleeve 2 for selectively coupling gear wheels 3 and 4. The gear wheels 3 and 4 are rotatable, but mounted in a fixed manner longitudinally on a transmission shaft 5. The shifting sleeve support 1 is rotationally fixed and longitudinally fixed on the transmission shaft 5 and carries the shifting sleeve 2 on its outer circumference. The shifting sleeve 2 is arranged on the shifting sleeve support 1 so as to be displaceable selectively in the direction of one of the gear wheels 3 or 4 and in a rotationally fixed manner relative to the shifting sleeve support 1 and thus to the transmission shaft 5 by means of a toothing. A set of synchroniser rings 13, 13′, 13″ is arranged on each side of the shifting sleeve support 1 longitudinally between the latter and the gear wheel 3, 4.

The shifting sleeve support 1 accommodates multiple detents 6 on its circumference, with a detent 6 only being shown schematically here. The detent 6 is designed as a pressure piece 9 and latches with its latching element 8 on the shifting sleeve 2 in its neutral setting position. In the neutral setting position, the detent 6 is supported radially on the shifting sleeve support 1 and is biased with a cover 10 against the shifting sleeve 2. The latching element 8 engages with its cover 10 in a latching recess 11.

If the shifting sleeve 2 is displaced axially, it engages in a clutch toothing 12a of a clutch disk 12 that is fixedly connected to the gear wheel 4. The transmission shaft 5 is connected for conjoint rotation with the gear wheel 4 via the shifting sleeve support 1 and the shifting sleeve 2, the gear associated with the gear wheel 4 being selected. During the shifting movement of the shifting sleeve 2 into the shifted position, the shifting sleeve 2 longitudinally takes along the latching element 8 of the detent 6, which engages in the latching recess 11, and displaces it against the outer synchroniser ring 13. This initiates the pre-synchronisation process.

The shifting sleeve 2, which is moved further in the direction of the clutch toothing 12a, forces the cover 10 of the pressure piece 9, which is supported on the outer synchroniser ring 13, out of the latching recess 11. The cover 10 deflects radially. When the gear is released, the shifting sleeve 2 moves back from this position. In this case, the cover 10 resting against the shifting sleeve 2 with bias engages again in the latching recess 11.

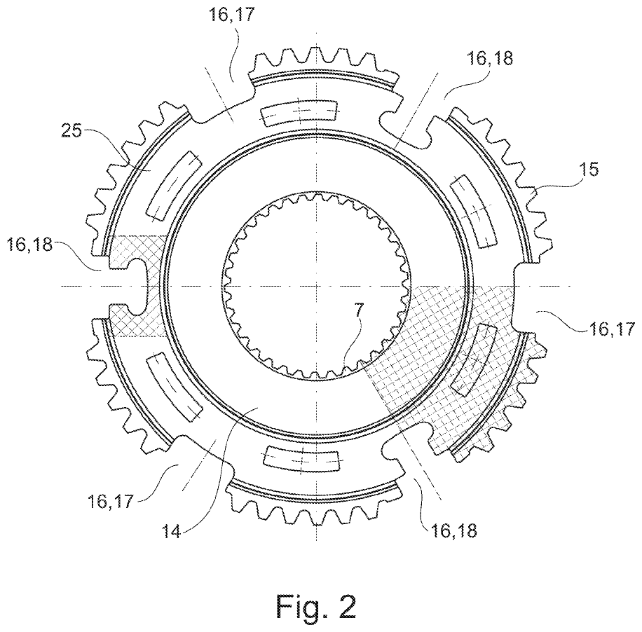

A shifting sleeve support 1 according to the prior art is shown in cross section in FIG. 2. It is designed as a one-piece hub and has an inner toothing 7 radially on the inside for rotationally fixed connection to the transmission shaft 5. A web 14 connects radially to the inner toothing 7 and connects the outer toothing 15 to the inner toothing 7. The outer toothing 15 is designed as a ring gear which is divided into individual toothed sections by six recesses in the form of grooves 16. Three of the grooves 16 constitute windows 17 for stops, not shown, arranged on the shifting sleeve 2. With an axial displacement of the shifting sleeve 2, the stops move in the grooves 16. The other three grooves 16 are designed as pressure piece windows 18. The pressure pieces 9 (FIG. 1) are arranged in them.

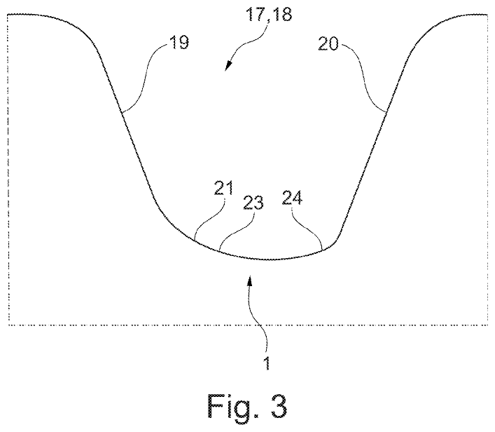

FIG. 3 shows a shifting sleeve support 1 according to the present disclosure with a groove 17 as a pressure piece window 18 for receiving a pressure piece 9. The groove 16 has two groove walls 19, 20, to each of which the groove bottom 21 is connected. The groove bottom 21 is composed of two partial surfaces 23, 24, each of which has a different curvature, so that the groove bottom is asymmetrical in order to relieve the web region 25 (FIG. 2) located in the direction of rotation 22. The curvature of the partial surfaces 23, 24 is not constant, as viewed in a cross-sectional plane over the groove bottom 21, but variable. The curvature of the partial surfaces 23, 24 also changes, viewed in a longitudinal section plane, over the groove bottom 21. The change in the curvatures of the partial surfaces 23, 24 does not take place in mirror-inverted manner, but independently of one another, it being ensured that the resulting groove bottom 21 is free of edges apart from the end faces of the shifting sleeve support 1.

The first groove wall 19 and the second groove wall 20 are each inclined at an angle to the center of the groove bottom 21, the two angles differing from one another.

### REFERENCE NUMERALS

1 Shifting sleeve support
2 Shifting sleeve
3 Gear Wheel
4 Gear wheel
5 Transmission shaft
6 Detent
7 Inner toothing
8 Latching element
9 Pressure piece
10 Cover
11 Latching recess
12 Clutch disc
12a Clutch toothing
13 Synchroniser ring
13′ Synchroniser ring
13″ Synchroniser ring
14 Web
15 Outer toothing
16 Groove
17 Window
18 Pressure piece window
19 Groove wall
20 Groove wall
21 Groove bottom
22 Direction of rotation
23 First partial surface
24 Second partial surface
25 Web region
26 Undercut
27 Synchronisation device

1.-8. (canceled)

9. A shifting sleeve support of a synchronisation device, comprising:
an outer toothing for meshing with a shifting sleeve; and
a groove, which interrupts the outer toothing, the groove comprising:
groove walls having an asymmetrical cross-section; and
a groove bottom.

10. The shifting sleeve support of claim 9, wherein the groove forms a pressure piece receptacle.

11. The shifting sleeve support of claim 9, wherein the groove forms a stop for the shifting sleeve.

12. The shifting sleeve support of claim 9, wherein the groove forms a stop for a synchroniser ring.

13. The shifting sleeve support of claim 9, wherein the groove walls have a same design in different longitudinal sections.

14. The shifting sleeve support of claim 9, wherein a groove base contour is designed as a curve that is asymmetrical in relation to a center of the groove bottom.

15. The shifting sleeve support of claim 9, wherein the groove walls form different angles with respect to the groove bottom.

16. The shifting sleeve support of claim 9, wherein the shifting sleeve support is sintered.
